(19) United States
(12) Patent Application Publication
(10) Pub. No.: US 2013/0134089 A1
(43) Pub. Date: May 30, 2013

(54) METHOD AND SYSTEM FOR TREATING WASTEWATER

(71) Applicant: GENERAL ELECTRIC COMPANY, Schenectady, NY (US)

(72) Inventor: Pierre Lucien COTE, Dundas (CA)

(73) Assignee: GENERAL ELECTRIC COMPANY, Schenectady, NY (US)

(21) Appl. No.: 13/686,160

(22) Filed: Nov. 27, 2012

Related U.S. Application Data
(60) Provisional application No. 61/565,069, filed on Nov. 30, 2011.

(51) Int. Cl. C02F 3/30

(52) U.S. Cl. CPC C02F 3/30
USPC 210/605; 210/150

(57) ABSTRACT

A wastewater treatment process uses enhanced primary treatment to remove suspended solids from raw wastewater. Primary sludge is treated in a fermenter. Primary effluent is treated by biological nutrient removal (BNR) to produce a treated effluent and waste activated sludge (WAS). The WAS is treated in an anaerobic digester, which also treats sludge from the fermenter. Anaerobic digestate is separated to provide a liquid effluent. The liquid effluent is stripped of phosphorous and returned to the BNR as a source of readily biodegradable carbon. Liquid in the fermenter may also be separated to provide a liquid rich in volatile fatty acids (VFAs). This liquid is returned to the BNR when additional VFAs are required.

This application claims the benefit of U.S. Provisional Application No. 61/565,069, filed Nov. 30, 2011, which is incorporated herein by reference.

### FIELD

The present disclosure relates generally to methods and systems for treating wastewater and, in particular, to systems and methods using biological processes and membrane separation.

### BACKGROUND

The following discussion is not an admission that anything discussed below is common general knowledge or citable as prior art.

In a conventional municipal sewage treatment plant using an activated sludge process, the sewage passes sequentially through pre-treatment, primary treatment and secondary treatment. In pre-treatment, large solids and grit are removed, for example by a coarse screen and a hydrocyclone. In primary treatment, a clarifier is used to separate the sewage into a primary sludge and a primary effluent. In secondary treatment, the primary effluent is converted into mixed liquor and treated under various forms of biological nutrient removal (BNR). Mixed liquor leaving the BNR section of the plant is separated in a secondary clarifier into a treated effluent and activated sludge. The activated sludge is divided into a return activated sludge (RAS) which returns to the BNR section, and a waste activated sludge (WAS). The primary sludge and the WAS may be treated further in an anaerobic digester.

The BNR section of the plant is used to remove biological oxygen demand (BOD), nitrogen (N) and possibly phosphorous (P) from the primary effluent. BOD and COD are generally removed in aerated tanks by aerobic microorganisms. To remove phosphorous and nitrogen, mixed liquor is treated in various zones where the redox conditions are controlled, for example an anaerobic zone, followed by an anoxic zone, followed by an aerobic zone. In the anaerobic zone, microorganisms consume volatile fatty acids (VFAs), create polyhydroxylalkonates (PHAs) and release phosphorous. In the anoxic zone, some microorganisms reduce nitrate to nitrogen gas while consuming organic carbon, and phosphorous accumulating organisms (PAOs) consume PHAs and uptake phosphorous. In the aerobic zone, PAOs consume additional PHAs and uptake more phosphorous, and other microorganisms convert ammonia to nitrate. Phosphorous is removed from the system with the WAS.

U.S. Pat. No. 6,982,036 describes a wastewater treatment process comprising chemically enhanced primary treatment (CEPT), BNR, and fermenting the primary sludge. The CEPT involves adding typical coagulants or flocculants, such as ferric chloride, ferrous chloride, ferrous sulfate, polyaluminum chloride (PACL) or aluminum sulfate, to wastewater in a primary sedimentation basin. The CEPT remove a higher percentage of the BOD and totals suspended solids (TSS) in the influent wastewater compared to an ordinary clarifier. Primary sludge from the CEPT is sent to the fermenter. Fermented sludge is fed to a gravity thickener to produce a VFA rich supernatant. The VFA rich supernatant is returned to a mixing junction between the CEPT and the BNR to provide a VFA enriched feed to the BNR.

### INTRODUCTION TO THE INVENTION

The following discussion is intended to introduce the reader to the detailed discussion to follow, and not to limit any claimed invention. A claimed invention may relate to a sub-combination of elements, processes or steps described below, or to a combination of one or more elements, processes or steps described below with an element or step described in other parts of this specification.

In order to use BNR to consistently remove N and P to very low levels, appropriate amounts of readily biodegradable COD (rbCOD) and VFAs must be available to the microorganisms. While fermenting primary sludge, and mixing a VFA rich supernatant with the primary effluent, increases the amount of VFA available for BNR, the supernatant also contains suspended solids. When returned to the BNR system, the fermenter supernatant contributes to the influent COD loading. In addition, when the concentration of VFAs exceeds the amount needed to facilitate P release, this excess concentration of VFAs also increases the loading of the BNR system.

In part of a wastewater treatment system and process described in this specification, WAS is fed to a digestor coupled with a solid-liquid separation device, for example an anaerobic membrane bioreactor (AnMBR), which produces a digestate liquid potion. This digestate liquid portion is treated to chemically remove phosphorous or other nutrients from it. The nutrient depleted permeate solution rbCOD and a low concentration of VFAs and is returned to the BNR. Optionally, phosphorous may be removed as a useful product such as struvite. Optionally, the WAS may be solubilized before it is digested.

In another part of a wastewater treatment system and process described in this specification, primary sludge is fed to a fermenter. Some fermented sludge flows through a solid-liquid separation system to produce a VFA rich permeate. This is done when a BNR process requires additional VFA. Optionally, primary clarifier effluent may be used as make up water to replace the volume of VFA rich liquid portion removed. The primary sludge may be generated by an enhanced primary treatment. The fermented sludge may be treated further in an anaerobic digester.

The two parts described above may be combined together. The resulting wastewater treatment system is able to provide a high quality effluent despite variations in wastewater influent characteristics. The system provides a controllable source of rbCOD to facilitate denitrification, and provides a controllable source of VFAs to facilitate phosphorus or other nutrient accumulation and removal. Organic matter is converted to biogas and phosphorous can be recovered.

### BRIEF DESCRIPTION OF THE DRAWINGS

FIG. 1 is a schematic illustration of a wastewater treatment system.

### DETAILED DESCRIPTION

In a wastewater treatment process, 50% or more of the suspended solids (SS) in influent wastewater are removed through primary treatment. The primary sludge is treated first in a fermenter and then in an anaerobic digester. Remaining fine solids in the primary effluent are treated in a BNR bioreactor.

25% or more of the COD in the influent wastewater is also removed from the wastewater with the primary sludge. Soluble and colloidal COD remaining in the primary effluent is oxidized in the BNR bioreactor, or converted into cell mass which leaves the BNR as WAS. The WAS is sent to the anaerobic digester.

Phosphorous is taken up in the BNR bioreactor, transferred to the digester with the WAS, and extracted in soluble form from the anaerobic digester as permeate from a solid-liquid separation unit associated with the anaerobic digester. The phosphorous is chemically removed from the permeate, for example by adding a metal salt to produce struvite.

Nitrogen is removed from the wastewater by nitrification and denitrification in the BNR bioreactor. This includes some nitrogen contained in solids and cell mass in the primary sludge or WAS, or both, that are extracted from the fermenter or digester, or both, in soluble form and later returned to the BNR bioreactor. Some nitrogen in the form of ammonia is extracted in permeate from the anaerobic digester and may be precipitated with phosphorous as struvite.

Nitrogen and phosphorous removal in the BNR bioreactor is assisted by returning phosphorous depleted permeate from the anaerobic digester to the BNR bioreactor. Optionally a VFA rich permeate is drawn from the fermenter and returned to the BNR bioreactor when a further source of VFA is required to meet a specified phosphorous concentration in the final plant effluent.

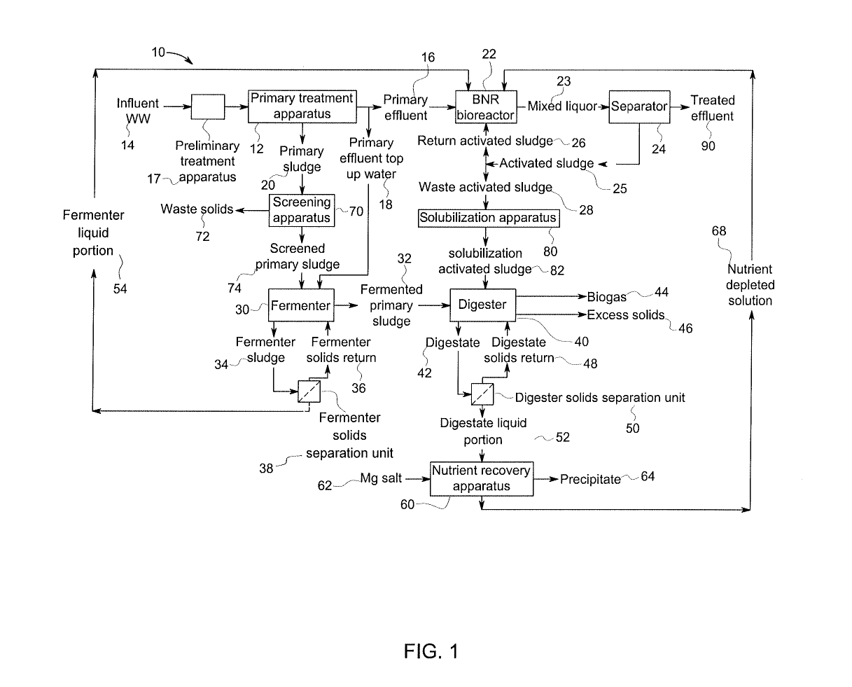

A wastewater treatment system (10) is illustrated in FIG. 1. The wastewater treatment system (10) includes a primary treatment apparatus (12), a BNR bioreactor (22), typically comprising multiple tanks, a fermenter (30), an anaerobic digester (40), a digester solids separation unit (50), and a phosphorous recovery apparatus (60). The digester solids separation unit (50) is a solid-liquid separation device that retains solids and preferably produces a substantially solids free liquid. For example, the digester solids separation unit may be a membrane unit or a microsieve. The primary treatment apparatus (12) receives an influent wastewater (14) to be treated, and provides a primary effluent (16) and a primary sludge (20). The primary effluent (16) is received by the BNR bioreactor (22), which provides an activated sludge (25) and a treated effluent (90). A first portion of the activated sludge (25), referred to as a return activated sludge (RAS) (26), is returned to the BNR bioreactor (22). A second portion of the activated sludge (25), referred to as waste activated sludge (WAS) 28, is received by the anaerobic digester (40). The primary sludge (20) is received by the fermenter (30), and provides a fermented primary sludge (32), which is also received by the anaerobic digester (40). The anaerobic digester (40) provides a digestate (42), a biogas (44) and excess solids (46). The digestate (42) is received by a digester solids separation unit (50), and provides a digestate solids return (48), which is received by the anaerobic digester (40), and a digestate liquid portion (52), which is received by a nutrient recovery apparatus (60). The nutrient recovery apparatus (60) provides a precipitate (64) and a nutrient depleted solution (68), which is received by the BNR bioreactor (22). The nutrient depleted solution (68) provides a source of rbCOD, and some VFAs, to the BNR bioreactor (22) to facilitate nutrient removal. The treated effluent (90) is reduced in nutrients, particularly phosphorus and nitrogen, which are detrimental when concentrated in a body of water receiving the treated effluent (90).

The primary treatment apparatus (12) is adapted to provide a primary sludge (20) having most of the influent suspended solids and 25% more of the influent COD in the influent wastewater 14. This facilitates producing VFAs in the fermenter (30) and biogas in the digester (40). The primary treatment apparatus (12) provides enhanced primary treatment and may be, for example, a lamella clarifier or a micro sieve. Micro sieves are available, for example, from Salnes Filter. The primary treatment apparatus (12) may produce a primary sludge (20) having about 60 to 70% of the influent wastewater suspended solids and about 30 to 40% of the influent wastewater COD. The primary sludge (20) typically has a phosphorus concentration of less than about 0.5% as P by weight.

The BNR bioreactor (22) is configured to biologically remove nutrients, particularly nitrogen and phosphorus. The BNR bioreactor (22) may contain one or more aerobic, anoxic and anaerobic zones or tanks and the BNR reactor (22) may have one or more recycle loops to return a least a portion of the activated sludge (25) to the BNR reactor (22). A recycle loop facilitates nitrification and denitrification and biological phosphorous removal.

The BNR bioreactor solids retention time (SRT) is greater than a time needed to achieve growth of autotrophic bacteria and facilitate nitrification but may be less than a time needed to achieve extensive aerobic oxidation of volatile solids. The SRT of the BNR bioreactor (22) may be at least about 8 to 12 days depending on temperature. The BNR bioreactor (22) may operate, for example, according to one of the processes described in EPA 832-R-08-006 (Kang et al., 2008) which are incorporated by reference.

The BNR bioreactor (22) includes a separator (24) to separate mixed liquor 23 into the activated sludge (25) and the treated effluent (90). The separator (24) may be a conventional clarifier or a microfiltration or ultrafiltration membrane unit, for example a ZeeWeed® membrane from GE Water and Process Technologies. The membrane unit may be submerged within the BNR bioreactor (22) or external to the BNR bioreactor (22) as shown in FIG. 1. The WAS (28) may have 2.0% or more of P by weight.

The BNR bioreactor (22) preferably includes one or more anaerobic zones. In an anaerobic zone in a conventional activated sludge plant, there is hydrolysis and fermentation of incoming COD to produce VFAs and uptake of the VFAs by PAOs to release P. The performance of the anaerobic zone is often highly variable due to variations in the input of COD, retention time and temperature. In the system (10), hydrolysis and fermentation are provided by a fermenter (30) and a fermenter liquid portion (54) containing COD and readily uptakable VFAs is added to the BNR bioreactor (22) when required. The fermenter liquid portion (54) contains essentially no suspended solids.

The fermenter liquid portion (54) is added to an upstream anaerobic zone within the BNR bioreactor (22) based on demand for VFAs. Demand for VFAs can be determined, for example, by measurements of soluble P, redox potential or other parameters. A sensor reading one or more parameters may be linked to a controller that delivers fermenter liquid portion (54) only when needed to improve the release of phosphorous. The fermenter liquid portion (54) may also contain some soluble P and N as ammonia that will be further treated in the BNR bioreactor (22).

The nutrient depleted solution (68) provides a source of rbCOD to the BNR bioreactor (22) and may include some VFAs. The nutrient depleted solution (68) may include ammonia but has little or no P. The nutrient depleted solution (68) is sent to the BNR bioreactor (22) to provide COD and some VFAs to the BNR bioreactor (22), and to treat the nutrient depleted solution (68). The rbCOD and VFAs provided by the nutrient depleted solution (68) may be sufficient during at least some periods of operation to meet the needs for nutrient removal in the BNR bioreactor (22) such that an acceptable treated effluent (90) is produced without further nutrient addition. In these cases, returning fermenter liquid portion (54) to the BNR bioreactor (22) is optional. The nutrient depleted solution (68) may be added to the BNR bioreactor (22) from the same place as the fermenter liquid portion (54) or from a different place. The return of the nutrient depleted solution (68), and optionally the fermenter liquid portion (54), allows a high quality treated effluent (90) to be produced.

The anaerobic digester (40) and digester solids separation unit (50) are operated as a membrane bioreactor in which the digester solids retention time (SRT) and hydraulic retention time (HRT) are controlled separately. The anaerobic digester SRT is between about 15 to 30 days to facilitate a desired percentage of volatile solids destruction. The anaerobic digester HRT is between about 5 to 15 days. The concentration of total solids in the anaerobic digester (40) is preferably kept generally constant. The total solids concentration should be as high as possible to minimize digester volume provided that the contents can be mixed and the membranes can be operated without plugging. The concentration of total solids in the anaerobic digester (40) may be between about 20 to 50 g/L, preferably between about 30 to 40 g/L. The temperature in the anaerobic digester (40) may be maintained in the mesophilic range, for example between about 30 to 38° C. Alternatively, the temperature in the anaerobic digester (40) may be maintained in the thermophilic range, for example between about 50 to 57° C.

Optionally, the wastewater treatment system (10), may include a solubilization apparatus (80). The waste activated sludge (28) is received by the solubilization apparatus (80), which produces a solubilized activated sludge (82). The step of solubilization breaks open the cells of microorganisms present in the waste activated sludge (28) to facilitate their digestion in the digester (40). The solubilization apparatus (80) may be a mechanical device, for example an ultrasonic device or a ball mill. Alternatively, the solubilization apparatus may involve a chemical treatment (e.g., lime or ozone), an electrical treatment (e.g., a focused pulse), or a heat treatment device.

The digester solids separation unit (50) may be a membrane unit and may operate in a pressurized vessel, with transmembrane pressure provided by a feed pump. Alternatively, the digester solids separation unit (50) may be a membrane unit immersed in a separate tank or within the anaerobic digester (40) with digestate liquid portion (52) removed by suction. The biogas (44) and excess solids (46) produced by the anaerobic digester (40) may be further treated to produce energy or compost respectively using methods known in the art.

Phosphorous is removed from the digestate liquid portion (52) by chemical precipitation. Optionally, the phosphorous may be removed in the form of a useful product. For example, the nutrient recovery apparatus (60) receives a magnesium salt (62) to produce a precipitate of magnesium ammonium phosphate (MAP), or struvite. The magnesium salt (62), preferably magnesium chloride, is added in an approximately stoichiometric amount to phosphate in order to precipitate the MAP. Ammonia is also required, but there is likely to be at least enough ammonia present in the digestate liquid portion (52). The resulting nutrient depleted solution (68) that will be sent to the BNR bioreactor (22) has a negligible concentration of phosphorous and a reduced concentration of ammonia.

The nutrient recovery apparatus (60) may be a reactor, such as a completely stirred tank reactor (CSTR), having an integrated clarifier. The CSTR may be mixed by sparging air, which also strips carbon dioxide and increases pH. If required, the pH in the nutrient recovery apparatus (60) may be adjusted, for example by the addition of a strong base such as sodium hydroxide. Struvite precipitates form in the reactor as dense fine particles that settle well since the digestate liquid portion (52) is essentially free of suspended solids. The settled precipitates can be dried to obtain struvite powder. Alternatively, the reactor may be coupled to a hydrocyclone for concentrating the struvite powder. The digestate liquid portion (52) can also be fed to a commercial struvite extraction device. For example, Ostara Nutrient Recovery Technologies sells a fluidized bed reactor as described in U.S. Pat. No. 7,622,047 that forms struvite granules.

The fermenter (30) treats the primary sludge 20 and, at some times, produces fermenter liquid portion (54). The fermenter (30) effects the first stages, hydrolysis and acidification, of the digestion of the primary sludge (30). A fermented primary sludge (32) flows to the digester (40) to continue the digestion process. While not producing fermented liquid portion (54), the fermenter (30) operates as a completely stirred tank reactor (CSTR) chemostat with a hydraulic retention time (HRT) of about 1 to 5 days, preferably about 1 to 3 days. The HRT favours the growth of hydrolysis and acidification microorganisms over the growth of gas production microorganisms, for example methanogens. The fermenter (30) can be operated at ambient temperature. Alternatively, the fermenter (30) can be heated and operate in the mesophilic range, for example between about 25 to 40° C.

The creation of fermenter liquid portion (54) is advantageous, but optional since the system (10) may be operate with a return of nutrient depleted solution (68) only. It is desirable to use the nutrient-depleted solution (68) as a feed solution for the BNR bioreactor (22) since the nutrient-depleted solution (68) is concentrated in rbCOD and contains some VFAs. The rbCOD and VFA provide a food source for the microorganisms, particularly the denitrifiers and the PAOs, to maximize nutrient removal. At some times, it is desirable to use the nutrient-depleted solution (68) and the membrane filtered fermenter liquid portion (54) as feed solutions for the BNR bioreactor (22) since the membrane filtered fermenter liquid portion (54) is concentrated in VFAs and contains some rbCOD.

To create fermenter permeate (54) when desired, the fermenter (30) may be coupled with a fermenter solids separation unit (38). The fermenter solids separation unit (38) is a solid-liquid separation unit that may be, for example, a membrane unit or a microsieve. Alternatively, when desired, fermenter sludge (34) may be filtered through the digester solids separation unit (50), thus providing a mixed fermenter liquid portion (54) and nutrient depleted solution (68). The fermenter sludge (34) is sent to the digester solids separation unit (50) or the fermenter solids separation unit (38) only when desired to increase nutrient removal in the BNR bioreactor (22).

A fermenter solids return (36) returns retentate from the fermenter solids separation unit (38) to the fermenter (30). When fermenter sludge (34) is treated in the digester solids separation unit (50), retained solids from the fermenter sludge (34) may be sent to the digester (40) with the digester solids return (48). Some primary effluent (16) may be sent to the fermenter (30) as primary effluent top up water (18). The top up volume may be roughly equivalent to the volume of fermenter liquid portion (54) received by the BNR bioreactor (22).

The fermenter liquid portion (54) contains some rbCOD and is rich in VFAs. The fermenter liquid portion (54) is produced and sent to the BNR bioreactor (22) when there is a demand for it, but when there is no such demand fermenter sludge (34) is not withdrawn from the fermenter (30). The fermenter solids separation unit (38), if any, is shut down or put into a waiting mode.

The fermenter solution (34) is filtered through a membrane when the BNR bioreactor (22) requires an additional source of rbCOD or VFAs that can be provided by the fermenter liquid portion (54). The additional source of rbCOD and VFAs is provided to meet the needs for nutrient removal in the BNR bioreactor. The fermenter liquid portion (54) may also include soluble P and ammonia. The location at which the fermenter liquid portion (54) is added to the BNR bioreactor (22) may be the same or different from the location at which the nutrient depleted solution (68) is added to the BNR bioreactor (22).

Membrane filtration separates the VFAs from the biomass and so stops the conversion of the VFAs to biogas. Accordingly, the fermenter liquid portion (54) may be stored and it is not necessary for the time that fermenter liquid portion (54) is created to be precisely the same time that the fermenter liquid portion (54) is used. Instead, the fermenter liquid portion (54) may be produced before or as it is needed.

Optionally, the wastewater treatment system (10) may include a screening apparatus (70). The primary sludge (20) is received by the screening apparatus (70), which provides a waste solids (72) and a screened primary sludge (74). The screening apparatus (70) may have openings between about 1-2 mm and removes particles and trash from the primary sludge (20) prior to introducing the screened primary sludge (74) into the fermenter (30). The screening apparatus (70) may be a mechanical device, for example a rotary drum screen.

The system (10) may include a preliminary treatment apparatus (17) for de-gritting the influent wastewater (14). The preliminary treatment apparatus (17) may also have a coarse screen, for example in the range of 3-6 mm. The preliminary treatment apparatus (17) removes larger particles and grit from the influent wastewater (14).

This written description uses examples to disclose the invention and also to enable any person skilled in the art to practice the invention, including making and using any devices or systems and performing any incorporated methods. The patentable scope of the invention is defined by the claims, and may include other examples that occur to those skilled in the art.

What is claimed is:

1. A wastewater treatment system comprising:
a primary treatment apparatus adapted to receive an influent wastewater, and to produce a primary effluent and a primary sludge;
a biological nutrient removal bioreactor adapted to receive at least a portion of the primary effluent, and to produce a treated effluent and an activated sludge, wherein a first portion of the activated sludge is returned to the biological nutrient removal bioreactor;
a fermenter adapted to receive the primary sludge, and to produce a fermented primary sludge;
an anaerobic digester having a digester membrane, the anaerobic digester adapted to receive the fermented primary sludge and a second portion of the activated sludge, and to produce a digester liquid portion;
a phosphorous removal apparatus adapted to receive the digester liquid portion, and to produce a phosphorous depleted solution; and
a primary feed system adapted to feed at least a portion of the phosphorous depleted solution to the biological nutrient removal bioreactor.

2. The wastewater treatment system according to claim 1, wherein the fermenter and the digester membrane are adapted to produce a fermenter liquid portion on demand;
the system further comprising:
a secondary feed system adapted to feed at least a portion of the fermenter liquid portion to the biological nutrient removal bioreactor.

3. The wastewater treatment system according to claim 1, wherein the fermenter includes a fermenter solids separation unit, and the fermenter and the fermenter solids separation unit are adapted to produce a fermenter liquid portion on demand;
the system comprising:
a secondary feed system adapted to feed at least a portion of the fermenter liquid portion to the biological nutrient removal bioreactor.

4. The wastewater treatment system according to claim 1 comprising a screening apparatus adapted to receive the primary sludge, and to produce a waste stream and a screened primary sludge, wherein the screened primary sludge is fed to the fermenter.

5. The wastewater treatment system according to claim 1 comprising a solubilization apparatus adapted to receive the second portion of the activated sludge, and to produce a solubilized activated sludge, wherein the solubilized activated sludge is fed to the anaerobic digester.

6. The wastewater treatment system according to claim 1, wherein the nutrient recovery apparatus is adapted to receive a magnesium salt, and to produce a struvite precipitate, wherein phosphorus and ammonia are removed from the digester permeate.

7. The wastewater treatment system according to claim 1, wherein the fermenter has a fermenter hydraulic retention time adapted to favor growth of hydrolysis and acidification microorganisms over the growth of methanogenesis microorganisms.

8. The wastewater treatment system according to claim 7, wherein the fermenter hydraulic retention time is between about 1 and 5 days.

9. The wastewater treatment system according to claim 2, wherein the fermenter is adapted to receive a portion of the primary effluent while fermenter permeate is produced.

10. The wastewater treatment system according to claim 9, wherein the volume of the primary effluent received by the fermenter is about equivalent to the volume of fermenter liquid portion received by the biological nutrient removal bioreactor.

11. The wastewater treatment system according to claim 1, wherein the anaerobic digester has a digester hydraulic retention time of about 5 to 15 days and a digester solids retention time of about 15 to 30 days.

12. The wastewater treatment system according to claim 1 wherein the primary treatment apparatus provides enhanced primary treatment.

13. The wastewater treatment system according to claim 1 wherein the biological nutrient removal bioreactor operates at a solids retention time of at least 8 days.

14. An apparatus for fermenting sludge comprising:
a anaerobic fermenter adapted to receive a first sludge, and to produce a VFA concentrated solution and a fermented sludge; and,
a solid-liquid separation unit to separate suspended solids from the VFA concentrated solution and produce a fermenter liquid portion.

15. The apparatus according to claim 13, wherein the fermenter hydraulic retention time is between about 1 to 5 days.

16. The apparatus according to claim 13, wherein the first sludge has a phosphorus concentration of less than about 0.5 wt %.

17. The apparatus of claim 13 further comprising a source of dilution water to replace fermenter liquid portion removed from the apparatus.

18. The apparatus of claim 13 further comprising an anaerobic digester coupled with a solid-liquid separation unit adapted to receive the fermented sludge and a second sludge and to produce a digestate liquid portion.

19. The apparatus of claim 18, wherein the second sludge has a phosphorous concentration of about 2.0 wt % or more.

20. The apparatus of claim 18 further comprising a phosphorous removal reactor adapted to receive the digestate liquid portion and produce a phosphorous depleted solution.

21. The apparatus of claim 18 wherein the anaerobic digester coupled with a solid-liquid separation unit comprises an anaerobic membrane bioreactor.

22. A method for treating wastewater comprising
providing a biological nutrient removal bioreactor with a primary treatment solution to produce a treated effluent and an activated sludge;
fermenting a primary sludge to produce a fermented primary sludge;
anaerobically digesting at least a portion of the fermented primary sludge and a portion of the activated sludge, to produce a digested solution;
removing suspended solids and nutrients from the digested solution, to produce a nutrient depleted, rbCOD concentrated solution; and
feeding a least a portion of the nutrient depleted, rbCOD concentrated solution to the biological nutrient removal bioreactor.

23. The method according to claim 22, wherein fermenting the primary sludge produces a fermented solution;
the method comprising:
removing suspended solids from the fermented solution, to produce a VFA concentrated solution; and
feeding a least a portion of the VFA concentrated solution to the biological nutrient removal bioreactor.

24. The method according to claim 22, comprising:
adding a magnesium salt to the digested solution to produce a struvite precipitate.

25. The method according to claim 22, wherein the suspended solids are removed by membrane filtration.

26. The method according to claim 22, wherein the nutrients are phosphorus and nitrogen.

27. The method according to claim 23, comprising:
varying a feed rate of the VFA concentrated solution to the biological nutrient removal bioreactor to maintain a nutrient concentration in the treated effluent at a predetermined level.

28. A method for treating wastewater comprising
providing a biological nutrient removal bioreactor with a primary effluent to produce a treated effluent and an activated sludge;
fermenting a primary sludge to produce a fermented primary sludge and a fermented solution;
removing suspended solids from the fermented solution to produce a VFA concentrated solution; and
feeding a least a portion of the VFA concentrated solution to the biological nutrient removal bioreactor.

29. The method according to claim 28 comprising a step of determining an amount of VFA that would increase the removal of phosphorous in the biological nutrient removal reactor and providing the determined amount of VFA by adding VFA concentrated solution to the biological nutrient removal bioreactor.
